(19) United States
(12) Patent Application Publication
(10) Pub. No.: US 2025/0159277 A1
(43) Pub. Date: May 15, 2025

(54) DATA PROCESSING METHOD, APPARATUS, DEVICE AND STORAGE MEDIUM

(71) Applicant: Beijing Zitiao Network Technology Co., Ltd., Haidian District, Beijing (CN)

(72) Inventor: Yuan WANG, Beijing (CN)

(21) Appl. No.: 18/715,948

(22) PCT Filed: Nov. 24, 2022
(86) PCT No.: PCT/CN2022/134046

§ 371 Date: Jun. 3, 2024

(30) Foreign Application Priority Data
Dec. 10, 2021 (CN) 202111506438.3

(51) Int. Cl. H04N 21/431; G06F 3/0485; H04N 21/2187; H04N 21/81

(52) U.S. Cl. CPC H04N 21/4316; G06F 3/0485; H04N 21/2187; H04N 21/8153

(57) ABSTRACT

The present disclosure provides a data processing method and apparatus, a device, and a storage medium. The method comprises: firstly, when it is detected that a first live video in a live preview state or a live playback state is played on a first page, displaying in a first display area preset on the first page display images respectively corresponding to a plurality of display objects associated with the first live video; and then, when a preset triggering operation for the first display area is received, displaying a floating window on the first page, and displaying on the floating window the plurality of display objects in the first display area and interaction controls respectively corresponding to the display objects, the interaction controls being configured for triggering a preset interaction behavior for a corresponding display objects.

### CROSS-REFERENCE TO RELATED APPLICATIONS

The present application is based on and claims priority to CN Patent Application No. 202111506438.3 filed on Dec. 10, 2021, the disclosure of which is incorporated by reference herein in its entirety.

### TECHNICAL FIELD

The present disclosure relates to the field of data processing, in particular to a data processing method, apparatus, device and a storage medium.

### BACKGROUND

With the continuous development of internet video live technology, people's needs for peripheral functions of video live are becoming more and more diversified.

Therefore, how to satisfy diversified needs of a user for peripheral functions of video live so as to enhance the user experience is an urgent technical problem to be solved at present.

### SUMMARY

In order to solve the above-described technical problems or at least partially solve the above-described technical problems, the embodiment of the present disclosure provides a data processing method, which is capable of enriching the gameplay of peripheral functions of video live so as to enhance the user experience.

In a first aspect of the present disclosure, a data processing method is provided. The method comprises: when it is detected that a first live video in a live preview state or a live playback state is played on a first page, displaying display images respectively corresponding to a plurality of display objects associated with the first live video in a first display area preset on the first page; wherein the first live video pertains to a first information stream; and in response to a preset trigger operation for the first display area, displaying a floating window on the first page, and displaying on the floating window the plurality of display objects in the first display area and interaction controls respectively corresponding to the plurality of display objects; wherein the interaction control is configured to trigger a preset interaction behavior for a corresponding display object.

In an alternative embodiment, the first information stream further includes a first image set including one or more images, and after the step of displaying the display images respectively corresponding to the plurality of display objects associated with the first live video in the first display area preset on the first page, the method further comprises: in response to an operation of switching from the first live video to the first image set, displaying the first image set on the first page; and in response to a trigger operation for a first image in the first image set, displaying the first image and a first interaction control corresponding to the first image on an object preview page; wherein the first interaction control is configured to trigger a preset interaction behavior for a display object associated with the first image.

In an alternative embodiment, the method further comprises: displaying an image in the first image set in a second display area preset on the object preview page; and in response to a preset trigger operation for the second display area, displaying a floating window on the object preview page, and displaying on the floating window a display object respectively corresponding to an image in the second display area and an interaction control corresponding to the display object; wherein the interaction control is configured to trigger a preset interaction behavior for the display object.

In an alternative embodiment, after the step of displaying the first image and the first interaction control corresponding to the first image on the object preview page in response to the trigger operation for the first image in the first image set, the method further comprises: in response to a preset sliding operation for the first image displayed on the object preview page, switching from the first image to a second image; wherein the second image pertains to the first image set.

In an alternative embodiment, the first information stream further includes a first video, and after the step of displaying the display images respectively corresponding to the plurality of display objects associated with the first live video in the first display area preset on the first page, the method further comprises: in response to an operation of switching from the first live video to the first vide, displaying a display object associated with the first video and an interaction control corresponding to the display object in a third display area preset on the first page; wherein the interaction control is configured to trigger a preset interaction behavior for the display object.

In an alternative embodiment, the first information stream is determined based on a video and/or image posted by an account followed by a current user.

In an alternative embodiment, the method further comprises: in response to a preset trigger operation for the first live video, jumping from the first page to a live room page corresponding to the first live video.

In a second aspect of the present disclosure, a data processing apparatus is provided. The apparatus comprises: a first display module configured to, when it is detected that a first live video in a live preview state or a live playback state is played on a first page, display in a first display area preset on the first page display images respectively corresponding to a plurality of display objects associated with the first live video; wherein the first live video pertains to a first information stream; and a second display module configured to, in response to a preset trigger operation for the first display area, display a floating window on the first page, and display on the floating window the plurality of display objects in the first display area and interaction controls respectively corresponding to the plurality of display objects; wherein the interaction control is configured to trigger a preset interaction behavior for a corresponding display object.

In a third aspect of the present disclosure, a computer-readable storage medium is provided. The computer-readable storage medium has instructions stored thereon that, when run on a terminal device, cause the terminal device to implement the method described above.

In a fourth aspect of the present disclosure, a device is provided. The device comprises: a memory, a processor, and a computer program stored in the memory and executable on the processor, wherein the method described above is implemented when the processor executes the computer program.

In a fifth aspect of the present disclosure, a computer program product is provided. The product comprises computer programs/instructions that, when executed by a processor, implement the method described above.

In a sixth aspect of the present disclosure, a computer program is provided. The computer program comprises instructions that, when executed by a processor, cause the processor to perform the method described above.

### BRIEF DESCRIPTION OF THE ACCOMPANYING DRAWINGS

The accompanying drawings here, which are incorporated into the specification and constitute part of this specification, show the embodiments conforming to the present disclosure and serve to explain the principles of the present disclosure together with the specification.

In order to explain the technical solutions in the embodiments of the present disclosure or in the prior art more clearly, the accompanying drawings required to be used in the description of the embodiments or the prior art will be briefly introduced below. Obviously, for those of ordinary skill in the art, other accompanying drawings may also be obtained according to these accompanying drawings without paying inventive effort.

FIG. 1 is a flow chart of a data processing method provided by an embodiment of the present disclosure;

FIG. 2 is a schematic view of a first page provided by an embodiment of the present disclosure;

FIG. 3 is a schematic view of another first page provided by an embodiment of the present disclosure;

FIG. 4 is a schematic view of a floating window provided by an embodiment of the present disclosure;

FIG. 5 is a schematic view of a further first page provided by an embodiment of the present disclosure;

FIG. 6 is a schematic view of displaying a first image set provided by an embodiment of the present disclosure;

FIG. 7 is a schematic view of an object preview page provided by an embodiment of the present disclosure;

FIG. 8 is a schematic structural view of a data processing apparatus provided by an embodiment of the present disclosure;

FIG. 9 is a schematic structural view of a data processing device provided by an embodiment of the present disclosure.

### DETAILED DESCRIPTION

In order to understand the above-described objects, features and advantages of the present disclosure more explicitly, the solution of the present disclosure will be further described below. It is to be noted that, the embodiments of the present disclosure and the features in the embodiments may be combined with each other in the case where contradiction is absent.

In the following description, many specific details will be elaborated in order to adequately understand the present disclosure. However, the present disclosure may also be implemented in other methods than that described here. Apparently, the embodiments in the specification are only some of the embodiments of the present disclosure, rather than all of the embodiments.

At present, if a user is interested in a display object in a live room, it is necessary to first enter the live room, and then click a shopping cart control in the live room to view the display object in the live room. Apparently, the above-described method requires the user to enter the live room and trigger multiple operations to view the display object in the live room, so that the process is complicated with a poor user experience.

In order to reduce the complexity of a function of viewing the display object in the live room by the user so as to enhance the user experience, the present disclosure provides a data processing method. First of all, when it is detected that a first live video in a live preview state or a live playback state is played on a first page, display images respectively corresponding to a plurality of display objects associated with the first live video are displayed in a first display area preset on the first page. Then, when a preset triggering operation for the first display area is received, a floating window is displayed on the first page, and the plurality of display objects in the first display area and interaction controls respectively corresponding to the display objects are displayed on the floating window, wherein the interaction control is configured to trigger preset interaction behaviors for a corresponding display object.

It can be seen that, in the data processing method provided by an embodiment of the present disclosure, the user may view a plurality of display objects in a live room without entering the corresponding live room during the process of browsing a live video, which simplifies the operation process of the function of viewing the display object in the live room by the user so as to enhance the user experience.

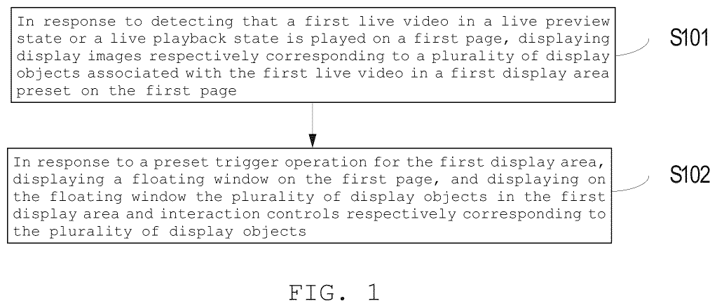

Based on this, an embodiment of the present disclosure provides a data processing method. Referring to FIG. 1, it is a flow chart of a data processing method provided by an embodiment of the present disclosure, and the method includes:

In S101, when it is detected that a first live video in a live preview state or a live playback state is played on a first page, display images respectively corresponding to a plurality of display objects associated with the first live video are displayed in a first display area preset on the first page.

Wherein, the first live video pertains to a first information stream.

In the embodiment of the present disclosure, the live preview state refers to a state of previewing live content in a live room before entering the live room, and the live playback state refers to a state of playing back a video that has been live-streamed after live ends.

In the embodiment of the present disclosure, the first information stream may include a plurality of videos, and the first information stream may include a recommended video stream, a search result video stream, a follow video stream or a hotspot video stream and the like, wherein the follow video stream may be determined based on a video and/or image posted by an account followed by a current user. The first page may be any page that is not a live room page. For example, the first page may be a page for displaying a live video in a recommended video stream.

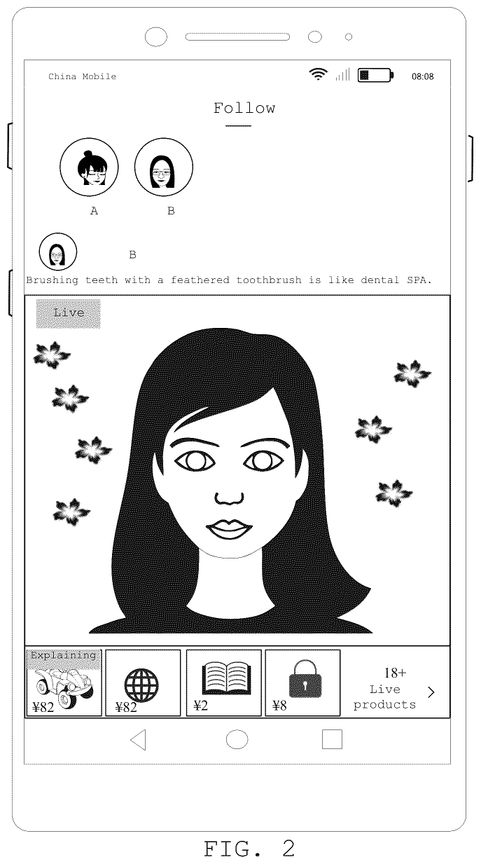

In an alternative embodiment, assuming that the first information stream is determined based on a video and/or image posted by an account followed by a current user, refer to FIG. 2, which is a schematic view of a first page provided by an embodiment of the present disclosure, wherein the first live video played on the first page pertains to a follow video stream under a “Follow” Tab, and the follow video stream is determined based on a video and/or image posted by an account “A”, “B” or the like followed by a current user.

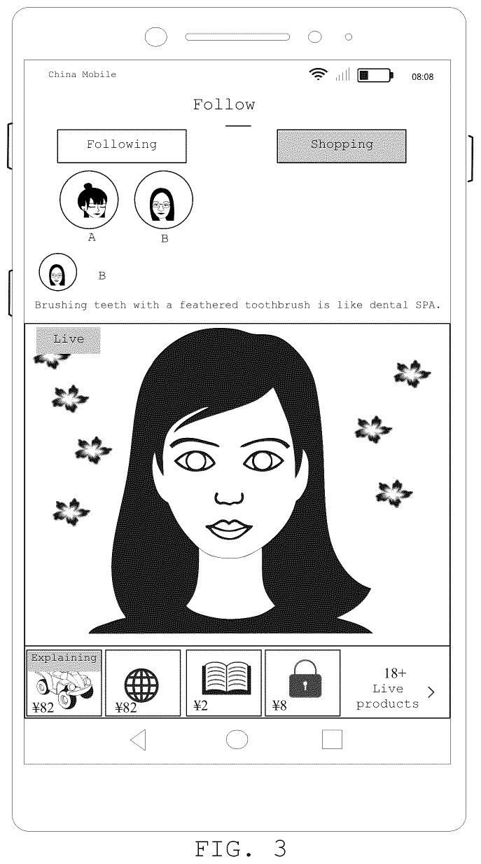

In another alternative embodiment, refer to FIG. 3, which is a schematic view of another first page provided by an embodiment of the present disclosure, wherein the first live video played on the first page pertains to a follow video stream under a “Shopping” sub-Tab of a “Follow” Tab, and the follow video stream may be determined based on a video and/or image posted by an account “A”, “B” or the like followed by a current user, or may be determined based on the features of a work posted by an account followed by a current user. It is to be noted that, the method of determining the first information stream is not limited by the embodiment of the present disclosure.

In practical application, during the process of displaying the first information stream, if it is detected that a first live video in a live preview state or a live playback state is played on a first page, display images respectively corresponding to a plurality of display objects associated with the first live video are displayed in a first display area preset on the first page. Wherein, the display objects associated with the first live video may be scenic spots, articles, services and the like displayed in the first live video.

As shown in FIG. 3, the first display area preset on the first page may be located at the bottom of the first page. In the first display area, the display image of each display object may be displayed according to a display order of the display object in the first live video. For display images of display objects that cannot be directly displayed in the first display area, they may be displayed in a folded manner. By clicking a folded area, the display images of the display objects displayed in fold may be viewed. In addition, the user may view the display images of the display objects displayed in fold in the first display area by triggering a left-right sliding operation for the first display area.

In addition, display objects displayed in the first display area are labelled with corresponding values respectively, for example, assuming that the display object is an article, the price of the article may be labelled. In addition, for the display object currently being displayed in the first live video, the wording “Explaining” may be displayed in a position corresponding to the display object in the first display area, so as to prompt the user of a current display progress of the first live video.

In an alternative embodiment, the first live video displayed on the first page is in a live preview state or a live playback state, and the user may enter a corresponding live room page based on the currently played first live video. Specifically, when a preset trigger operation for the first live video is received, a jump is made from the first page to a live room page corresponding to the first live video. Wherein, the preset trigger operation for the first live video may include a click operation on a “Enter Live Room” control corresponding to the first live video, or the like.

In S102, in response to a preset trigger operation for the first display area, a floating window is displayed on the first page, and the plurality of display objects in the first display area and interaction controls respectively corresponding to the plurality of display objects are displayed on the floating window.

Wherein, the interaction control is configured to trigger a preset interaction behavior for the display object.

In the embodiment of the present disclosure, when a preset trigger operation for the first display area on the first page is received, a floating window may be displayed on a page, and display objects in the first display area and interaction controls corresponding to the display objects may be displayed on the floating window. Wherein, the preset trigger operation for the first display area may include a click operation, a sliding operation and the like on the first display area.

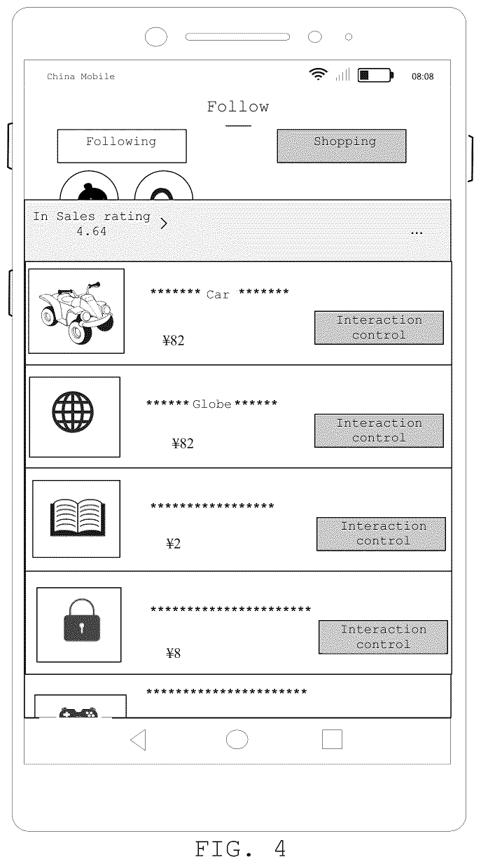

Referring to FIG. 4, it is a schematic view of a floating window provided by an embodiment of the present disclosure, wherein the display images and values of the display objects in the first display area, as well as the explanation orders thereof in the live room are displayed on the floating window. Specifically, it is possible to view each display object by sliding the floating window.

In an alternative embodiment, each display object may be displayed on the floating window according to a display order of the display object in the first live video, and each display object has a corresponding interaction control, so that the user may trigger a preset interaction behavior for a display article corresponding to the interaction control by clicking the interaction control.

In the embodiment of the present disclosure, the interaction controls may be configured to trigger preset interaction behaviors, which may include product transaction behaviors, product purchase behaviors, and the like.

In practical application, if the current user is interested in a display object in the first live video, it is not necessary to enter a live room corresponding to the first live video, but trigger a preset interaction behavior for the display object of interest directly through a corresponding relationship between each display object and an interaction control displayed on the floating window, which simplifies the interaction process so as to enhance the user experience.

In the data processing method provided by an embodiment of the present disclosure, first of all, when it is detected that a first live video in a live preview state or a live playback state is played on a first page, display images respectively corresponding to a plurality of display objects associated with the first live video are displayed in a first display area preset on the first page. Then, when a preset triggering operation for the first display area is received, a floating window is displayed on the first page, and the plurality of display objects in the first display area and interaction controls respectively corresponding to the display object are displayed on the floating window, wherein the interaction control is configured to trigger a preset interaction behavior for a corresponding display object. In the embodiment of the present disclosure, during the process of browsing a live video, the user may view a plurality of display objects in a corresponding live room without entering the live room, which simplifies the operation process of the function of viewing the display object in the live room by the user so as to enhance the user experience.

On the basis of the above-described embodiments, the first information stream provided by the embodiment of the present disclosure may include not only the first live video in a live preview state or a live playback state, but also a first video, wherein the first video may also be referred to as a short video, and the first video may be a video work posted by a short video author.

In practical application, during the process of browsing the first information stream, a user may trigger a switching of a video that is currently played in the first information stream by an operation such as slide up and down. Specifically, if an operation of switching from the first live video to the first video is received, display objects associated with the first video and an interaction control corresponding to each display object are displayed in a third display area preset on the first page; wherein the interaction control is configured to trigger a preset interaction behavior for a corresponding display object.

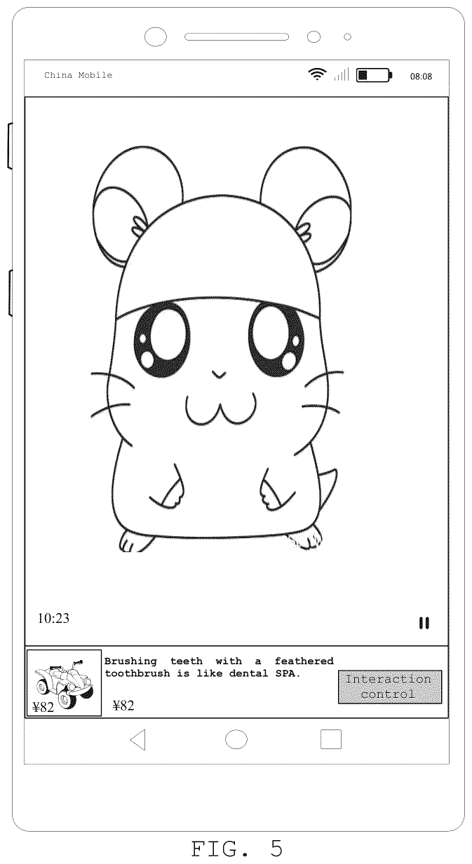

Referring to FIG. 5, it is a schematic view of a further first page provided by an embodiment of the present disclosure, wherein the display objects associated with the first video may include scenic spots, articles, services, and the like displayed in the first video, and the third display area preset on the first page may be located at the bottom of the first page, and display objects associated with the first video and corresponding interaction controls thereof are displayed in the third display area, and the user may trigger a preset interaction behavior for a display object corresponding to an interaction control by clicking the interaction control.

In practical application, if the current user is interested in a display object in the first video, a preset interaction behavior for the display object of interest may be triggered directly based on a corresponding relationship between an image of each display object displayed in the third display area on the first page and an interaction control, which simplifies the interaction process so as to enhance the user experience.

On the basis of the above-described embodiments, the first information stream provided by the embodiment of the present disclosure may include not only the first live video in a live preview state or a live playback state and the first video, but also a first image set. Wherein, the first image set includes one or more images, and images in the first image set may include images of products created by a seller in the background, images of products released by an author in own show case, and the like.

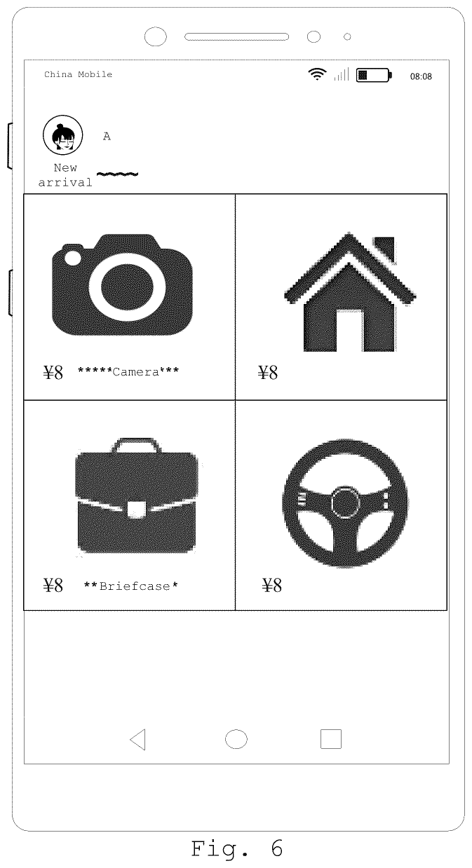

In practical application, during the process of browsing the first information stream, the user may trigger a switching of a video that is currently played in the first information stream by slide up and down. Specifically, if an operation of switching from the first live video to the first image set is received, the first image set is displayed on the first page. As shown in FIG. 6, it is a schematic view of displaying a first image set provided by an embodiment of the present disclosure, wherein the first image set may determine a display style based on the number of images contained therein, so that the first image set is displayed based on the determined display style. The display style shown in FIG. 6 is a display style that contains four images in the first image set, and usually no more than nine images may be directly displayed on the first page, and exceeded images may be displayed in fold. In addition, each image displayed on the first page may be labelled with the value of the display object corresponding to the image, for example, the value of an article.

In practical application, when a trigger operation for the first image in the first image set displayed on the first page is received, the first image and a corresponding first interaction control thereof may be displayed on an object preview page. Wherein, the first image may be any image in the first image set.

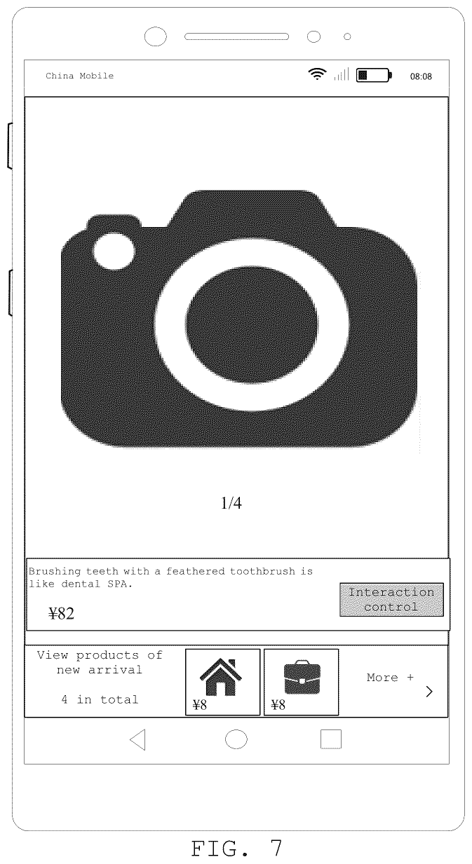

As shown in FIG. 7, it is a schematic view of an object preview page provided by an embodiment of the present disclosure, wherein a first image and a corresponding first interaction control are displayed on the object preview page, and the first interaction control is configured to trigger a preset interaction behavior for a display object associated with the first image.

In practical application, if the current user is interested in a display object in the first image set, an interaction behavior for the display object of interest may be triggered directly based on an interaction control corresponding to each image displayed on the first page, which simplifies the interactive process so as to enhance the user experience.

In addition, the object preview page in the embodiment of the present disclosure not only displays an interaction control of a display object associated with the image that is currently displayed, but also displays a display object associated with each image in the first image set in a second display area preset on the object preview page.

When a preset trigger operation for the second display area is received, a floating window may be displayed on the object preview page, and an image of each display object in the second display area and an interaction control corresponding to each display object may be displayed on the floating window, wherein the display style of the floating window may be understood with reference to the above-described FIG. 4, and the image of a display object in the second display area is the image of a display object respectively associated with each image in the first image set. Wherein, the interaction control is configured to trigger a preset interaction behavior for a corresponding display object.

In practical application, if the current user is interested in a display object in the first image set, a preset interaction behavior for the display object of interest may be triggered directly based on an interaction control corresponding to each image displayed on the floating window displayed on the object preview page, which simplifies the interaction process so as to enhance the user experience.

In an alternative embodiment, when a preset sliding operation for the first image displayed on the object preview page is received, the first image is switched to the second image, so as to switch an image that is currently displayed. Wherein, the first image and the second image may be images in the first image set with a sequential display order, and the preset sliding operation may include a left-right sliding operation, an up-down sliding operation and the like.

According to the data processing method provided by the embodiment of the present disclosure, during the process of browsing the video stream, the user may view a display object associated with a live video without entering the live room, which simplifies the interaction process of the user's preset interaction behavior for the display object of interest so as to enhance the user experience.

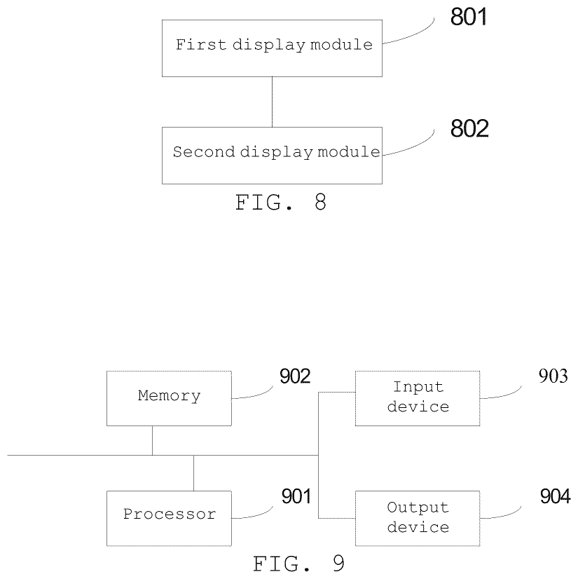

Based on the above-described method embodiments, the present disclosure also provides a data processing apparatus, and with reference to FIG. 8, it is a schematic structural view of a data processing apparatus provided by an embodiment of the present disclosure, and the apparatus comprises: a first display module 801 configured to display display images respectively corresponding to a plurality of display objects associated with the first live video in a preset first display area on a first page when it is detected that a first live video in a live preview state or a live playback state is played on a first page; wherein the first live video pertains to a first information stream; and a second display module 802 configured to, in response to a preset trigger operation for the first display area, display a floating window on the first page and display on the floating window the plurality of display objects in the first display area and interaction controls respectively corresponding to the plurality of display objects; wherein the interaction control is configured to trigger a preset interaction behavior for the display object.

In an alternative embodiment, the first information stream further includes a first image set including one or more images, and the apparatus comprises: a third display module configured to display the first image set on the first page in response to an operation of switching from the first live video to the first image set; and a fourth display module configured to display the first image and a first interaction control corresponding to the first image on an object preview page in response to a trigger operation for the first image in the first image set; wherein the first interaction control is configured to trigger a preset interaction behavior for a display object associated with the first image.

In an alternative embodiment, the apparatus further comprises: a fifth display module configured to display a display object associated with an image in the first image set in a second display area preset on the object preview page; and a sixth display module configured to display a floating window on the object preview page in response to a preset trigger operation for the second display area, and display the display objects respectively corresponding to the images in the second display area and interaction controls corresponding to the display objects on the floating window; wherein the interaction control is configured to trigger a preset interaction behavior for the display object.

In an alternative embodiment, the apparatus further comprises: a switching module for switching from the first image to the second image in response to a preset sliding operation for the first image displayed on the object preview page; wherein the second image pertains to the first image set.

In an alternative embodiment, the first information stream further includes a first video, and the apparatus further comprises: a seventh display module configured to display a display object associated with the first video and an interaction control corresponding to the display object in a third display area preset on the first page in response to an operation of switching from the first live video to the first video; wherein the interaction control is configured to trigger a preset interaction behavior for the display object.

In an alternative embodiment, the first information stream is determined by a video and/or image posted based on an account followed by a current user.

In an alternative embodiment, the apparatus further comprises: a jump module configured to jump from the first page to a live room page corresponding to the first live video in response to a preset trigger operation for the first live video.

The embodiment of the present disclosure provides a data processing apparatus. First of all, when it is detected that a first live video in a live preview state or a live playback state is played on a first page, a plurality of display objects associated with the first live video are displayed in a first display area preset on the first page. Then, when a preset triggering operation for the first display area is received, a floating window is displayed on the first page, and a plurality of display objects in the first display area and an interaction control respectively corresponding to each display object are displayed on the floating window, wherein the interaction control is configured to trigger a preset interaction behavior for a corresponding display object. In the embodiment of the present disclosure, during the process of browsing a live video, the user may view a plurality of display objects in a corresponding live room without entering the live room, which simplifies the operation process for the user to view the display object functions in the live room so as to enhance the user experience.

In addition to the above-described methods and devices, the embodiment of the present disclosure also provides a computer-readable storage medium having instructions stored thereon that, when run on a terminal device cause the terminal device to implement the data processing method described in the embodiment of the present disclosure.

The embodiment of the present disclosure also provides a computer program product including computer programs/instructions that, when executed by a processor, implement the data processing method described in the embodiment of the present disclosure.

The embodiment of the present disclosure also provides a computer program including instructions that, when executed by a processor, cause the processor to perform the data processing method described in the embodiment of the present disclosure.

In addition, the embodiment of the present disclosure also provides a data processing device, as shown in FIG. 9, which may comprise: a processor 901, a memory 902, an input device 903 and an output device 904. The number of processors 901 in the data processing device may be one or more, and one processor is taken as an example in FIG. 9. In some embodiments of the present disclosure, the processor 901, the memory 902, the input device 903 and the output device 904 may be connected through a bus or other means, wherein the connection through a bus is taken as an example in FIG. 9.

The memory 902 may be configured to store software programs and modules, and the processor 901 performs various functional applications and data processing of the data processing device by running the software programs and modules stored in the memory 902. The memory 902 may mainly include a program storage area and a data storage area, wherein the program storage area may store an operation system, an application program required by at least one function, and the like. In addition, the memory 902 may include a high-speed random access memory and a non-volatile memory, for example, at least one disk memory device, a flash memory device, or other volatile solid-state memory devices. The input device 903 may be configured to receive input digital or character information and generate a signal input related to a user setting and function control of the data processing device.

Specifically, in the present embodiment, the processor 901 will load executable files corresponding to the progress of one or more application programs into the memory 902 according to the following instructions, and the processor 901 will run the application programs stored in the memory 902 so as to realize various functions of the above-described data processing device.

It is to be noted that, the relational terms such as “first” and “second” herein are only used to distinguish one entity or operation from another entity or operation, but do not necessarily require or imply any such actual relationship or order present between these entities or operations. Moreover, the terms “comprising”, “including” or any other variation thereof are intended to cover non-exclusive inclusions, so that a process, method, article or device including a series of elements includes not only those elements, but also other elements not explicitly listed or elements inherent to such process, method, article or device. In the case where there are no more restrictions, an element defined by the phrase “including one . . . ” does not exclude an additional identical element also present in the process, method, article or device including the element.

The above content only pertains to a detailed description of the present disclosure, so that those skilled in the art may understand or realize the present disclosure. Multiple modifications to these embodiments will be obvious for those skilled in the art, and the general principles defined herein may be realized in other embodiments without departing from the spirit or scope of this disclosure. Therefore, the present disclosure will not be limited to these embodiments described herein, but intended to conform to the broadest scope consistent with the principles and novel features disclosed herein.

What is claimed is:

1. A data processing method, the method comprising:
in response to detecting that a first live video in a live preview state or a live playback state is played on a first page, displaying display images respectively corresponding to a plurality of display objects associated with the first live video in a first display area preset on the first page; wherein the first live video pertains to a first information stream; and
in response to a preset trigger operation for the first display area, displaying a floating window on the first page, and displaying on the floating window the plurality of display objects in the first display area and interaction controls respectively corresponding to the plurality of display objects; wherein the interaction control is configured to trigger a preset interaction behavior for a corresponding display object.

2. The method according to claim 1, wherein the first information stream further includes a first image set including one or more images, and after the step of displaying the display images respectively corresponding to the plurality of display objects associated with the first live video in the first display area preset on the first page, the method further comprises:
in response to an operation of switching from the first live video to the first image set, displaying the first image set on the first page; and
in response to a trigger operation for a first image in the first image set, displaying the first image and a first interaction control corresponding to the first image on an object preview page; wherein the first interaction control is configured to trigger a preset interaction behavior for a display object associated with the first image.

3. The method according to claim 2, wherein the method further comprises:
displaying an image in the first image set in a second display area preset on the object preview page; and
in response to a preset trigger operation for the second display area, displaying a floating window on the object preview page, and displaying on the floating window a display object respectively corresponding to an image in the second display area and an interaction control corresponding to the display object; wherein the interaction control is configured to trigger a preset interaction behavior for the display object.

4. The method according to claim 2, wherein after the step of displaying the first image and the first interaction control corresponding to the first image on the object preview page in response to the trigger operation for the first image in the first image set, the method further comprises:
in response to a preset sliding operation for the first image displayed on the object preview page, switching from the first image to a second image; wherein the second image pertains to the first image set.

5. The method according to claim 1, wherein the first information stream further includes a first video, and after the step of displaying the display images respectively corresponding to the plurality of display objects associated with the first live video in the first display area preset on the first page, the method further comprises:
in response to an operation of switching from the first live video to the first vide, displaying a display object associated with the first video and an interaction control corresponding to the display object in a third display area preset on the first page; wherein the interaction control is configured to trigger a preset interaction behavior for the display object.

6. The method according to claim 1, wherein the first information stream is determined based on a video and/or image posted by an account followed by a current user.

7. The method according to claim 1, wherein the method further comprises:
in response to a preset trigger operation for the first live video, jumping from the first page to a live room page corresponding to the first live video.

8. (canceled)

9. A non-transitory computer-readable storage medium having instructions stored thereon that, when run on a terminal device, cause the terminal device to implement steps of:
in response to detecting that a first live video in a live preview state or a live playback state is played on a first page, displaying display images respectively corresponding to a plurality of display objects associated with the first live video in a first display area preset on the first page; wherein the first live video pertains to a first information stream; and
in response to a preset trigger operation for the first display area, displaying a floating window on the first page, and displaying on the floating window the plurality of display objects in the first display area and interaction controls respectively corresponding to the plurality of display objects; wherein the interaction control is configured to trigger a preset interaction behavior for a corresponding display object.

10. A device comprising: a memory, a processor, and a computer program stored in the memory and executable on the processor, wherein the computer program, when executed by the processor, implements steps of:
in response to detecting that a first live video in a live preview state or a live playback state is played on a first page, displaying display images respectively corresponding to a plurality of display objects associated with the first live video in a first display area preset on the first page; wherein the first live video pertains to a first information stream; and
in response to a preset trigger operation for the first display area, displaying a floating window on the first page, and displaying on the floating window the plurality of display objects in the first display area and interaction controls respectively corresponding to the plurality of display objects; wherein the interaction control is configured to trigger a preset interaction behavior for a corresponding display object.

11-12. (canceled)

13. The non-transitory computer-readable storage medium according to claim 9, wherein the first information stream further includes a first image set including one or more images, and after the step of displaying the display images respectively corresponding to the plurality of display objects associated with the first live video in the first display area preset on the first page, the instructions further cause the terminal device to implement steps of:
in response to an operation of switching from the first live video to the first image set, displaying the first image set on the first page; and
in response to a trigger operation for a first image in the first image set, displaying the first image and a first interaction control corresponding to the first image on an object preview page; wherein the first interaction control is configured to trigger a preset interaction behavior for a display object associated with the first image.

14. The non-transitory computer-readable storage medium according to claim 13, wherein the instructions further cause the terminal device to implement steps of:
displaying an image in the first image set in a second display area preset on the object preview page; and
in response to a preset trigger operation for the second display area, displaying a floating window on the object preview page, and displaying on the floating window a display object respectively corresponding to an image in the second display area and an interaction control corresponding to the display object; wherein the interaction control is configured to trigger a preset interaction behavior for the display object.

15. The non-transitory computer-readable storage medium according to claim 13, wherein after the step of displaying the first image and the first interaction control corresponding to the first image on the object preview page in response to the trigger operation for the first image in the first image set, the instructions further cause the terminal device to implement steps of:
in response to a preset sliding operation for the first image displayed on the object preview page, switching from the first image to a second image; wherein the second image pertains to the first image set.

16. The non-transitory computer-readable storage medium according to claim 9, wherein the first information stream further includes a first video, and after the step of displaying the display images respectively corresponding to the plurality of display objects associated with the first live video in the first display area preset on the first page, the instructions further cause the terminal device to implement steps of:
in response to an operation of switching from the first live video to the first vide, displaying a display object associated with the first video and an interaction control corresponding to the display object in a third display area preset on the first page; wherein the interaction control is configured to trigger a preset interaction behavior for the display object.

17. The non-transitory computer-readable storage medium according to claim 9, wherein the first information stream is determined based on a video and/or image posted by an account followed by a current user.

18. The non-transitory computer-readable storage medium according to any of claim 9, wherein the instructions further cause the terminal device to implement steps of:
in response to a preset trigger operation for the first live video, jumping from the first page to a live room page corresponding to the first live video.

19. The device according to claim 10, wherein the first information stream further includes a first image set including one or more images, and after the step of displaying the display images respectively corresponding to the plurality of display objects associated with the first live video in the first display area preset on the first page, the computer program further implements steps of:
in response to an operation of switching from the first live video to the first image set, displaying the first image set on the first page; and
in response to a trigger operation for a first image in the first image set, displaying the first image and a first interaction control corresponding to the first image on an object preview page; wherein the first interaction control is configured to trigger a preset interaction behavior for a display object associated with the first image.

20. The device according to claim 19, wherein the computer program further implements steps of:
displaying an image in the first image set in a second display area preset on the object preview page; and
in response to a preset trigger operation for the second display area, displaying a floating window on the object preview page, and displaying on the floating window a display object respectively corresponding to an image in the second display area and an interaction control corresponding to the display object; wherein the interaction control is configured to trigger a preset interaction behavior for the display object.

21. The device according to claim 19, wherein after the step of displaying the first image and the first interaction control corresponding to the first image on the object preview page in response to the trigger operation for the first image in the first image set, the computer program further implements steps of:
in response to a preset sliding operation for the first image displayed on the object preview page, switching from the first image to a second image; wherein the second image pertains to the first image set.

22. The device according to claim 10, wherein the first information stream further includes a first video, and after the step of displaying the display images respectively corresponding to the plurality of display objects associated with the first live video in the first display area preset on the first page, the computer program further implements steps of:
in response to an operation of switching from the first live video to the first vide, displaying a display object associated with the first video and an interaction control corresponding to the display object in a third display area preset on the first page; wherein the interaction control is configured to trigger a preset interaction behavior for the display object.

23. The device according to claim 10, wherein the first information stream is determined based on a video and/or image posted by an account followed by a current user.
